(19) United States
(12) Patent Application Publication
(10) Pub. No.: US 2021/0050634 A1
(43) Pub. Date: Feb. 18, 2021

(54) METHOD FOR RECYCLING LITHIUM-ION BATTERIES

(71) Applicants: WECK + POLLER HOLDING GMBH, Zwickau (DE); WKS TECHNIK GMBH, Dresden (DE)

(72) Inventors: Matthias Schmidt, Brehna (DE); Marek Goeckerlitz, Kirchberg (DE); Doreen Paesold-Runge, Kirchberg (DE); Falk Goebel, Grossdittmansdorf (DE); Hannes Wienold, Dresden (DE); Pascal Mueller, Dresden (DE)

(21) Appl. No.: 16/963,500

(22) PCT Filed: Feb. 18, 2018
(86) PCT No.: PCT/EP2018/000065

§ 371 Date: Jul. 20, 2020

(51) Int. Cl. H01M 10/54; H01M 10/0525; H01M 4/525; H01M 4/38; H01M 4/133; H01M 4/134

(52) U.S. Cl. CPC H01M 10/54; H01M 10/0525; H01M 4/134; H01M 4/382; H01M 4/133; H01M 4/525

(57) ABSTRACT

The invention relates to a method for recycling lithium-ion batteries which have at least one cathode and an anode and the cathode is made of a base material and an active material arranged thereon.

### CROSS REFERENCE TO RELATED APPLICATIONS

This application is a national phase of the International Patent Application PCT/EP2018/000065 filed on Feb. 19, 2018.

### BACKGROUND OF THE INVENTION

The invention relates to a method for recycling rechargeable lithium-ion batteries.

The invention relates to a method in which the active materials of the anodes and cathodes of the rechargeable lithium-ion batteries can be recovered and reused in same or similar battery types.

Rechargeable lithium-ion batteries, also known as li-ion-batteries i.e. LIB, are currently especially used in the field of electric mobility and for portable electronic devices. Especially for electric automobiles, especially passenger cars, rechargeable lithium-ion batteries are primarily used.

The formation of such rechargeable lithium-ion batteries varies greatly by type. Today, cylindrical-shaped (tubular batteries) and flat-shaped batteries (pillow or rail) are commonly found. In these flat-shaped batteries, the cathode and the anode consistently have a flat (foil-like) form.

LIB-cathodes regularly feature a current-collector, for example aluminum foil, on which the active material is applied, which specifically serves the storage of lithium-ions.

One of these active materials is based on lithium-nickel-cobalt-manganese, abbreviated NMC or NCM. These NMC-cathodes are presently commonly used.

LIB-anodes regularly feature a current-collector, for example copper foil, on which active material is superimposed. In rechargeable lithium-ion batteries, carbon-based (graphite) anodes are often utilized.

In the focus of further development of rechargeable lithium-ion batteries and their widespread use, alongside actual development of batteries stands the establishment of recycling methods, which preferably enable a complete renewed life-cycle for lithium-ion battery at the end of their useful life, wherein recycling rates of over 90% are strived for. Piloted or experimentally implemented methods are based substantially on pyrometallurgical processes. According to the UBR-method (UMICORE), for example, the LIBs are melted without prior disassembly, resulting in a cobalt-nickel-copper alloy. Lithium and manganese are bound in the slag. In subsequent refinement processes, the individual metallic components (metal, lithium) are recovered separately.

An extraction of the active materials of a cathode, especially together with all individual metallic components, is not possible.

According to a to-date only laboratory tested method (Li, Guo et al. Advanced materials research 937. rr515-519, 2014), the LIB is divided into its components or assemblies.

After a thermal treatment, the active materials of the anodes and the cathodes are rinsed off by a water jet and subsequently subjected to a leaching process with sulfuric acid/hydrogen peroxide.

In doing so, the metallurgical bond of the active materials is disrupted. In further process steps, the dissolved metals are precipitated as carbonates or oxalates and further prepared.

All these processes have the disadvantage that they are specifically geared towards recovering the individual metallic components for commercial use. The provision of active materials in this manner requires a multi-stage process, requiring substantial effort.

### SUMMARY OF THE INVENTION

The object of the invention is to overcome the disadvantages of the state of the art and to provide a method for recycling rechargeable lithium-ion batteries, specifically with a LIB cathode, wherein the active material of the LIB-cathode fundamentally stays intact, so that they can be functionally used again after recycling, if applicable. Therein there should be no dissolution of the LIB cathode into its individual metallic components. The active material should only be removed from the carrier foil, and through appropriate refinement steps be freed from adhering electrolyte and conducting salt remains, wherein the composition and structure of the active materials stay intact to a great extent.

The object of the invention is achieved by a method for recycling rechargeable lithium-ion batteries, the batteries comprising at least one cathode and one anode, and the cathode comprising a base material and an active material provided on the base material, wherein the method comprises at least recycling the cathodes of the lithium-ion battery, wherein the cathode undergoes treatment in water or in an aqueous salt solution in order to separate the active materials from the base material of the cathode.

### DETAILED DESCRIPTION OF THE INVENTION

The technical contribution is that these processes contain at least the process step of recycling the cathodes of the rechargeable lithium-ion batteries, wherein the cathode undergoes treatment in water or an aqueous salt solution for the detaching of the active materials from the basis material of the cathode. Thereby it is achieved in a surprisingly simple manner and for the first time in a few easy steps, that the valuable active material of the electrodes is recovered in a reusable.

Advantages over the state-of-the-art:
The process is distinguished by its gentle conditions, allowing the composition and structure of the active materials to be maintained to a great degree, thus enabling their reuse.
It is not required to treat electrodes down to the materials used at the outset, as is typical in thermal processes.
Even the carbon part of the active material remains in a reusable form, whereas in thermal processing it is lost.
The process is thereby energetically and procedurally less work-intensive and cheaper.
The process ensures the cleansing of the active material from other components, which on basis of their use of the battery became a contaminant through partial decomposition of electrolyte and conducting salt.
The process is distinguished by its high recycling ratio of the active materials and the electrode base-materials (carrier foil).
The process avoids the formation of more poisonous and environmentally damaging exhaust gases and by-products.

The inventive process for recycling valuable components from rechargeable lithium-ion batteries thus enables cathodes and, if desired, also anodes, after prior mechanical dismantling of the rechargeable lithium-ion batteries and sorting, to separately undergo treatment in water or an aqueous salt solution, resulting in both the active material of the cathodes and, if desired, the active material of the anodes to each separate from the carrier foils effectively and exist in such a form which enables its reuse in rechargeable lithium-ion batteries.

The dependent claims 2 to 11 contain, without limitation, advantageous embodiments of the invention.

Preferably, the treatment is performed in an aqueous salt solution, specifically a sodium-hydrogen-carbonate based solution.

A sodium-hydrogen-carbonate solution is especially advantageous, as it speeds up the detachment of the active materials from the base material and has a positive influence in separating contaminants from the active material. The resultant pH values differ only slightly from neutral, to a large extent preventing the leaching of the metallic components from the active material. (sodium-hydrogen-carbonate is mass-produced and is thus obtainable at low costs).

Preferably the aqueous salt solution contains 0.1 to 2 mol/L of hydrogen-carbonate of the alkaline metal lithium, sodium, or potassium or the alkaline earth metal magnesium, calcium, or barium.

Thereby the known hydrogen-carbonate can be used, which is easily handled and relatively economical, especially at low concentration.

A proportion of these hydrogen-carbonates, which is preferably kept small, is necessary to carry out subsequent wastewater treatments relatively economically effectively.

Preferably, the treatment is conducted in water or an aqueous salt solution at temperatures of 10 to 60 degrees Celsius, especially preferred at temperatures >40 degrees Celsius.

It has been shown that this temperature range reliably removes contaminants that would be detrimental to subsequent use from the coating material.

Preferably, the coated anode and cathode foils separates adhering electrolyte components through an appropriate preceding process, especially preferably a vacuum evaporation, before being separated by the treatment in water or an aqueous salt solution and separately being recycled.

This is especially advantageous in that during the preparation of the active materials less electrolyte components get into the wastewater and the wastewater treatment can be conducted more economically.

Preferably, the ratio of treated electrode material to water or the aqueous salt solution is selected such that forming decomposition products of the electrolytes or the conducting salts are completely absorbed during the aqueous phase and no poisonous or environmentally damaging gas products are formed. Preferred and workable conditions are characterized by the water or the aqueous salt solution being used in ratios ranging from 25:1 to 100:1 to the treating electrode material.

Preferably, the lithium-ion battery features multiple cathodes (NMC-cathodes), whose active materials are based on lithium-nickel-cobalt-manganese and these cathodes each possess a flat form.

This is especially advantageous because these flat geometries enable simple opening of the cell pouch, for example through punching or cutting in a technically simple manner.

Preferably, the process contains the process step of disassembly of a multilayer-built lithium-ion battery through separation of the anodes and cathodes.

This is especially advantageous, since the exposed anodes and cathodes can be separately and highly-automatedly be sortedly separated. The then exposed anodes and cathodes can be separately and highly-automatedly sortedly separated, for example, through separate placement of cathodes and anodes on a conveyer belt, for example according to the FlexPicker principle. This prevents mixture of the cathode and anode materials, as it occurs during shredding, which in turn forms the basis for the reuse of the materials in batteries.

The object of the invention is further solved by the inventive process of extracting active material and/or base-material of a cathode from a lithium-ion battery.

Below, a possible implementation of such a process is described, without limiting this inventive process.

The process begins with the controlled discharge of rechargeable lithium-ion batteries. The thereby released energy can be used for heating purposes or as supply for an electricity network. After the discharge, the gradual dismantling of the rechargeable lithium-ion batteries is conducted down to the cell pouch level, wherein this is preferably achieved manually using diverse tools. The separated cell pouches can be disassembled by a further automated disassembly. Herewith, a clean separation of cathodes and anodes ensues.

The separated cathodes and anodes are separately moved to the next process step, in which the active material is dissolved from the carrier foil. The dissolution can be achieved in stirring tank reactors or industrial washing machines (also as conveyor belts). The active materials recovered by means of the cathodes and anodes are mechanically separated in a known manner, for example by means of filters, filter presses, centrifuges, and can subsequently be washed. This wash is followed by drying in a drying furnace. Subsequently, the powder is ready for dispatch. It is necessary that the treatment of the cathode and anode mass takes place at separate locations and/or times to avoid risk of masses mixing.

The exhaust air occurring during the process can be reduced by air cleaning processes, for example by means of an activated carbon absorber. Likewise, a process tank maintenance of the treatment baths can be performed, for example by means of membrane separation methods, which serves to reduce wastewater accumulation.

The recovered metallic foils of the copper-anode and the aluminum-cathode can be rinsed and then under pressure and temperature be pressed into bales ready for dispatch. This process is also conducted at a separate time and/or location to prevent the foils from mixing.

The object of the invention is further achieved by the inventive process of extracting active materials and/or base material of an anode from a lithium-ion battery.

Below, a possible implementation of such a process is described, without limiting this inventive process.

The process begins with the controlled discharge of rechargeable lithium-ion batteries. The released energy can be used for heating purposes or as supply for an electricity network. After the discharge, the gradual dismantling of the rechargeable batteries is conducted except for the cell pouch level, wherein this is preferably achieved manually using diverse tools. The separated cell pouches can be disassembled by a further automated disassembly. Herewith, a clean separation of cathodes and anodes ensues.

The separated cathodes and anodes are separately moved to the next process step, in which the active material is dissolved from the carrier foil. The dissolution can be achieved in stirring tank reactors or industrial washing machines (also as conveyor belts). The actives materials recovered by means of the cathodes and anodes are mechanically separated in a known manner, for example by means of filters, filter presses, centrifuges, and can subsequently be washed. This washing is followed by drying in a drying furnace. Subsequently, the powder is ready for dispatch. It is necessary that the treatment of the cathode and anode mass takes place at separate locations and/or times to avoid risk of masses mixing.

The recovered metallic foils of the copper-anode and the aluminum-cathode can be rinsed and then under pressure and temperature be pressed into bales ready for dispatch. This process also takes place at separate times and/or locations to prevent the foils from mixing.

The object of the invention is further achieved by a system for recycling rechargeable lithium-ion batteries operated in accordance with a process according to at least one of claims 1 to 11, wherein this system comprises at least one unit for the recycling of active materials and/or the base materials of a cathode of a lithium-ion battery.

The object of the invention is further achieved by a system for recycling rechargeable lithium-ion batteries operated in accordance with a process according to at least one of claims 1 to 11, wherein this system comprises at least one unit for the recycling of active materials and/or the base materials of an anode of a lithium-ion battery.

Disassembly of a Rechargeable Battery:

The disassembly comprises the steps of: opening the battery; discharging it; dismantling the cables, the ventilation, the fuses and the controls; dismantling the cell-stack from the rechargeable battery bath; and dismantling the circuit board series connection and exposed cell pouch together. These steps are done manually with the help of appropriate tools. The pouch is then automatically opened, preferred processes are hereby punching and cutting. Subsequently, the unmixed sorting of anode, cathode and separator film is conducted. This is robot-aid and can, for example, be accomplished by a FlexPicker process.

The anode and cathode material are brought to the next step in the process at separate locations and/or times; the disposal of the separator foil. The transportation of the said materials can, for example, be done through simple conveyor belts.

The pouch opening takes place under evacuating the atmosphere because it contains pollutants. These pollutants are absorptivity separated, for example by means of an activated carbon filter.

Below, the invention is discussed in more detail by three examples, without limiting the scope.

### EXAMPLE 1

27 g of coated foil-anodes from a lithium-ion traction battery are treated in a closed stirring tank comprising 1 mol/L of a sodium-hydrogen-carbonate solution with moderate stirring at a temperature of 30 degrees Celsius. After 20 minutes of reaction, the active material is completely dissolved by the electrode-base forming copper foil. The copper foil is separated, rinsed by water multiple times, dried, and the scrap metal evaluation is performed. The detached active anode material is washed in sequence by a 1 liter 0.1 M sodium-hydrogen-carbonate solution and 3 liters of distilled water, filtered and dried at 60-100 degrees Celsius until reaching a residual moisture content of <5 wt. %.

Out of 27 g of raw material, 7.8 g copper foil and 18.7 g active material is recovered.

### EXAMPLE 2

1460 g of coated cathode foil from a lithium-ion traction battery is washed in an industrial washing machine at a temperature of 40 degrees Celsius with 150 L of water. After 3 minutes of washing, more than 95% of the active material has separated from the electrode-basis-forming aluminum foil. The aluminum foil is separated, rinsed by water multiple times, dried, and the scrap metal evaluation is performed.

The separated active material of the cathode is filtered and dried at 60-120 Celsius until reaching a residual moisture content of <5 wt. %.

Out of 1460 g of raw material, 130 g aluminum foil and 1303 g active material is recovered.

The analytical study of the resultant wastewater yielded the following concentration values for the active material containing metals: cobalt 0.44 mg/l, nickel 0.51 mg/l, manganese 0.85 mg/l. Converted to the total waste water volume and the content of metals in the raw materials, this shows that only 0.4 to 0.9 per mil of metals are leached during the treatment. This proves that the metal oxide matrix of the active materials is not negatively affected by the treatment.

### EXAMPLE 3

45 kg NMC active material is recovered by the process of example 2. This active material was subject to a comparative study of the nickel, manganese, and cobalt composition, benchmarked against new material. The composition of recycled active materials corresponds fully to the given tolerance of concentration values of the metals for new material.

The recycled active materials are introduced to a grinding process to adjust the particle size to that of the new material. Through addition of binders and further additives, a coating material is produced, which corresponded to the composition of new cathode materials. After the coating, the recycled cathodes were integrated into an automotive battery.

In a practical test, the battery with recycled active materials achieved electric characteristic values of >98% compared to a new battery.

An adequate attempt was conducted with the active material of the anodes. Herein, approximately 32 kg of anode active material was recovered. Further, this material was dried, grinded, and then used for the new coating of an anode cord.

The battery test yielded electric characteristic values of approximately 85% compared to a new battery. By replacing just 10% of the recycled material with new material of equal mass, electric characteristic values of 95% can be achieved.

What is claimed is:

1. A method for recycling rechargeable lithium-ion batteries, the batteries comprising at least one cathode and one anode, and the cathode comprising a base material and an active material provided on the base material, wherein the method comprises at least recycling the cathodes of the lithium-ion battery, wherein the cathode undergoes treatment in water or in an aqueous salt solution in order to separate the active materials from the base material of the cathode.

2. The method for recycling rechargeable lithium-ion batteries according to claim 1, the treatment being conducted in an aqueous salt-solution, which is preferably a sodium-hydrogen-carbonate based solution.

3. The method for recycling rechargeable lithium-ion batteries according to claim 1, the aqueous salt solution containing 0.1 to 2 mol/L of hydrogen-carbonate of the alkaline metals lithium, sodium, or potassium or the alkaline earth metals magnesium, calcium, or barium.

4. The method for recycling rechargeable lithium-ion batteries according to claim 1, the treatment being conducted in an aqueous salt solution at temperatures of 10 to 60 degrees Celsius.

5. The method for recycling rechargeable lithium-ion batteries according to claim 1, further comprising separating from the coated anode and cathode foils adhering electrolyte components through an appropriate preceding process, especially preferably a vacuum evaporation, prior to the treatment in water or an aqueous salt solution, and recycling the electrolyte components separately.

6. The method for recycling rechargeable lithium-ion batteries according to claim 1, the ratio of treated electrode material to water or to an aqueous salt solution being selected such that forming decomposition of the electrolytes or the conducting salts are completely absorbed by the aqueous phase and no poisonous or environmentally damaging gas products are formed.

7. The method for recycling rechargeable lithium-ion batteries according to claim 1, the lithium-ion batteries comprising multiple cathodes (NMC-cathodes), whose active materials are based on lithium-nickel-cobalt-manganese.

8. The method for recycling rechargeable lithium-ion batteries according to claim 1, the lithium-ion batteries comprising anodes, which are carbon-based (graphite) and have a flat base form.

9. The method for recycling rechargeable lithium-ion batteries according to claim 1, the process having the process steps of disassembling a multilayer-built lithium-ion battery by separating of the anodes and cathodes.

10. The method for recycling rechargeable lithium-ion batteries according to claim 9, the disassembly being performed mechanically.

11. The method for recycling rechargeable lithium-ion batteries according to claim 1, the anodes and cathodes separately undergoing treatment in water or an aqueous salt solution after prior mechanical dismantling of the rechargeable lithium-ion batteries and sorting, resulting in both the anode and cathode active materials being separated from the electrode base material with high recuperation rates.

12. The active material and/or base material of a cathode recovered from a lithium-ion battery according to the method of claim 1.

13. The active material and/or base material of an anode recovered from a lithium-ion battery according to the method of claim 1.

14. A system for recycling rechargeable lithium-ion batteries according to the method of claims 1, wherein the system comprises at least one unit for recycling the active materials and/or the base materials of a cathode of a lithium-ion battery (foil 23).

15. A system for recycling rechargeable lithium-ion batteries according to claim 14, wherein the system comprises at least one unit for recycling the active materials and/or the base materials of an anode of a lithium-ion battery.
